(19) United States
(12) Patent Application Publication
(10) Pub. No.: US 2018/0004502 A1
(43) Pub. Date: Jan. 4, 2018

(54) BASIC INPUT/OUTPUT SYSTEM (BIOS) UPDATE CONTROL

(71) Applicant: Dell Products L.P., Round Rock, TX (US)

(72) Inventors: Balasingh Samuel, Round Rock, TX (US); Walter Phillips, Georgetown, TX (US); Steven Downum, Pflugerville, TX (US)

(21) Appl. No.: 15/198,941

(22) Filed: Jun. 30, 2016

(51) Int. Cl. G06F 9/445; G06F 9/44

(52) U.S. Cl. CPC G06F 8/65; G06F 9/4411

(57) ABSTRACT

A basic input/output system (BIOS) may be automatically updated by a BIOS distribution service. In certain environments such automatic updates may not be desirable as the update may not have been tested or may cause interruptions in one or more information handling systems or applications. Updating an extensible firmware interface system resource table (ESRT) with one or more values may disable such automatic updates. A BIOS version control policy may be utilized to determine the one or more values for the ESRT such that BIOS updates are not automatic or that only predetermined, tested, or otherwise approved BIOS updates are permitted. One or more values of the BIOS version control policy may be set or determined and may be protected, for example, password protected so that all information handling systems within a given environment or network maintain the proper BIOS version.

### BACKGROUND

### Field of the Disclosure

This disclosure relates generally to information handling systems and more particularly to controlling updates to a basic input/output system (BIOS), for example, automatic capsule updates to the BIOS.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In certain information handling systems, a basic input/output system (BIOS) may include BIOS firmware for various hardware management tasks. A BIOS may be updated to a new version or even a previous version. A BIOS update may be initiated automatically when a new BIOS version is posted on BIOS update service server. It may be desirable to prevent such automatic updates to protect the integrity and operation of the information handling system.

### SUMMARY

In one or more embodiments, a system and method for a version control of a basic input/output (BIOS) of an information handling system is provided. An interface for the BIOS may be provided for altering one or more parameters, wherein the one or more parameters are associated with a version control policy for the BIOS. The one or more parameters may comprise at least one of enable automatic updates, disable automatic updates and permit predetermined updates. The altering the one or more parameters may comprise any one or more of altering the enable automatic updates to allow automatic updates of the BIOS by the distribution service, and wherein the BIOS version comprises a current version of the BIOS; altering the disable automatic updates to prevent automatic updates of the BIOS by the distribution service, and wherein the BIOS version comprises an empty value; and altering the one or more parameters comprises altering the permit predetermined updates to restrict updates of the BIOS by the distribution service, wherein the one or more parameters comprises a predetermined BIOS version, and wherein the BIOS version comprises the predetermined BIOS version. In one or more embodiments, the predetermined BIOS version may be an earlier version than a current version of the BIOS of the information handling system. An extensible firmware interface system resource table (ESRT) may be populated with one or more values based, at least in part, on the one or more parameters, wherein the one or more values are indicative of a unique identifier associated with the BIOS and a BIOS version, and wherein the BIOS version is based, at least in part, on the version control policy. The one or more values may be provided to a BIOS distribution service where the BIOS distribution service may host one or more firmware or BIOS updates for any one or more firmware device types. The BIOS of the information handling system may be updated with a BIOS update from the BIOS distribution service based, at least in part, on the one or more values provided to the BIOS distribution service. The version control policy of the information handling system may be associated with any one or more information handling systems.

In one or more embodiments, an information handling system may comprise a memory and a processor coupled to the memory, wherein the processor has access to the BIOS, wherein the BIOS includes one or more instructions stored in the memory and executable by the processor to perform any one or more steps of any one or more embodiments. In one or more embodiments, a non-transitory computer-readable medium storing one or more instructions, the one or more instructions representing the BIOS, that, when executed by a processor of an information handling system, cause the processor to perform any one or more steps of any one or more embodiments.

Other disclosed aspects include article of manufacture comprising a non-transitory computer-readable medium storing instructions executable by a processor, and the information handling system comprising a processor subsystem having access to the BIOS.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system for controlling updates to a BIOS according to one or more aspects of the present disclosure;

FIG. 2 is a block diagram of selected elements of an embodiment of an information handling system for controlling updates to a BIOS according to one or more aspects of the present disclosure; and

FIG. 3 is a flowchart depicting selected elements of an embodiment of a method for controlling updates to a BIOS according to one or more aspects of the present disclosure.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

For purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer (for example a desktop or a laptop), a tablet computer, a mobile device (for example, a personal digital assistant (PDA or smart phone), server (for example, a blade server or a rack server), a consumer electronic device, a network storage device, or another suitable device and may vary in size, shape, performance, functionality, and price. The information handling system may include memory (for example, volatile and nonvolatile memory), one or more processing resources such as a central processing unit (CPU) or hardware or software control logic. Additional components of the information handling system may include one or more disk drives, one or more storage devices, one or more communications ports (for example, network ports) for communicating with external devices as well as various input and output (I/O) devices, such as a keyboard, a mouse, a touchscreen and a video display. The information handling system may also include one or more buses operable to transmit communication between the various hardware components.

Additionally, the information handling system may include firmware for controlling or communicating with or both, for example, hard drives, network circuitry, memory devices, I/O devices, and other peripheral devices. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, a computer-readable non-transitory storage medium or media may include one or more semiconductor-based or other integrated circuits (ICs) (such as, for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate. A computer-readable non-transitory storage medium may include an instrumentality or aggregation of instrumentalities that may retain data or one or more instructions or both for a period of time. A computer-readable non-transitory storage medium include, without limitation, storage media such as a direct access storage device (for example, a hard disk drive or floppy disk), a sequential access storage device (for example, a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

As noted previously, certain information handling systems may include BIOS firmware that may control certain hardware elements and may provide for user management of the hardware elements. As will be described in further detail herein, a BIOS non-volatile memory may store BIOS firmware and one or more BIOS update policies included in the information handling system. The components may be hardware components or software components or both. In this manner, only approved or predetermined BIOS updates will be initiated. The methods and systems described herein for controlling BIOS updates may enable, for example, administrator control over BIOS versions for one or more information handling systems.

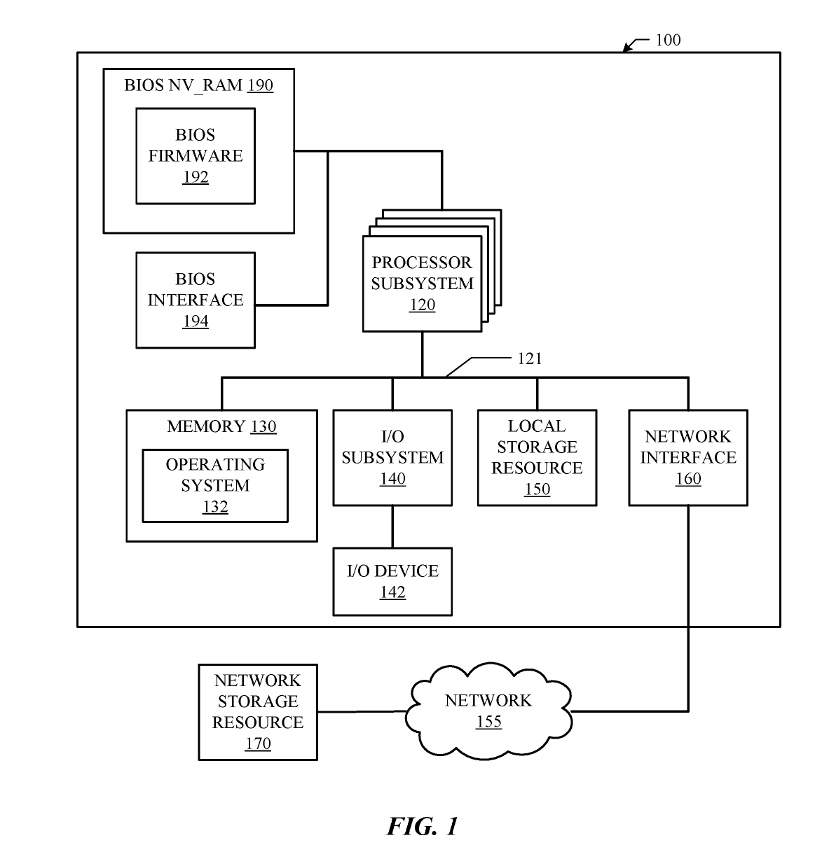

Particular embodiments are best understood by reference to FIGS. 1, 2, and 3 wherein like numbers are used to indicate like and corresponding parts.

Turning now to the drawings, FIG. 1 illustrates a block diagram depicting selected elements of an embodiment of information handling system 100. Also shown with information handling system 100 are external or remote elements, namely, network 155 and network storage resource 170.

As shown in FIG. 1, components of information handling system 100 may include, but are not limited to, processor subsystem 120, which may comprise one or more processors, and system bus 121 that communicatively couples various system components to processor subsystem 120 including, for example, memory 130, I/O subsystem 140, local storage resource 150, and network interface 160. System bus 121 may represent a variety of suitable types of bus structures, for example, a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, Video Electronics Standards Association (VESA) local bus, any other suitable bus, or any combination thereof.

In FIG. 1, network interface 160 may be a suitable system, apparatus, or device operable to serve as an interface between information handling system 100 and a network 155. Network interface 160 may enable information handling system 100 to communicate over network 155 using a suitable transmission protocol and/or standard, including, but not limited to, transmission protocols and/or standards enumerated below with respect to the discussion of network 155. In some embodiments, network interface 160 may be communicatively coupled via network 155 to network storage resource 170. Network 155 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network 155 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 155 and its various components may be implemented using hardware, software, or any combination thereof. In certain embodiments, information handling system 100 and network 155 may be included in a rack domain.

As depicted in FIG. 1, processor subsystem 120 may comprise a system, device, or apparatus operable to or designed to interpret or execute program instructions, process data, or any combination thereof and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret or execute program instructions, process data stored locally (for example, in memory 130 and/or another component of physical hardware 102), or any combination thereof. In the same or alternative embodiments, processor subsystem 120 may interpret or execute program instructions, process data stored remotely (for example, in a network storage resource) or any combination thereof.

Also in FIG. 1, memory 130 may comprise a system, device, or apparatus operable to or designed to retain or retrieve program instructions or data or both for a period of time (for example, computer-readable media). In one or more embodiments, memory 130 may internal to or external to information handling system 100. As shown in the example embodiment of FIG. 1, memory 130 stores operating system 132, which may represent instructions executable by processor subsystem 120 to operate information handling system 100 after booting of the BIOS firmware 192. It is noted that in different embodiments, operating system 132 may be stored at network storage resource 170 and may be accessed by processor subsystem 120 via network 155 Memory 130 may comprise random access memory (RAM), electrically erasable programmable read-only memory (EEPROM), a PCMCIA card, solid-state memory, flash memory, magnetic storage, opto-magnetic storage, and/or a suitable selection and/or array of volatile or non-volatile memory that retains data after power to its associated information handling system, such as information handling system 100, is powered down. In one or more embodiments, memory 130 or network storage resource 170 or both may include one or more storage control units (not shown) for facilitating communication between processor subsystem 120 and any one or more the memory 130 and network storage resource 170.

Local storage resource 150 may comprise a computer-readable non-transitory storage medium (for example, hard disk drive, floppy disk drive, CD-ROM, other type of rotating storage media, flash memory, EEPROM, another type of solid state storage media, or any combination thereof) and may be generally operable to store instructions or data or both. For example, local storage resource 150 may store executable code in the form of program files that may be loaded into memory 130 for execution.

In information handling system 100, I/O subsystem 140 may comprise hardware, software, a system, device, or apparatus generally operable to receive or transmit data to, from, or within (or any combination thereof) information handling system 100 and one or more I/O devices 142. Information handling system 100 may comprise one or more I/O devices 142, where appropriate. In one or more embodiments, one or more I/O devices may be remote from the information handling system 100. I/O subsystem 140 may represent, for example, a variety of communication interfaces, graphics interfaces, video interfaces, user input interfaces, peripheral interfaces or any combination thereof. As an example and not by way of limitation, an I/O device 142 may include a keyboard, keypad, microphone, monitor, mouse, printer, scanner, speaker, still camera, stylus, tablet, touch screen or touch panel, trackball, display adapter, video camera, another suitable I/O device or a combination of two or more of these. An I/O device 142 may include one or more sensors. This disclosure contemplates any suitable I/O devices 142 and any suitable I/O subsystems 140. Where appropriate, I/O subsystem 140 may include one or more devices or software drivers enabling processor subsystem 120 to drive one or more I/O devices 142. I/O subsystem 140 may include one or more I/O interfaces to interface to any one or more I/O devices 142, where appropriate. Although this disclosure describes and illustrates a particular I/O subsystem 140, this disclosure contemplates any suitable I/O subsystem.

Also shown in FIG. 1 is BIOS non-volatile random access memory (NV-RAM) 190, often simply or collectively referred to as the ‘BIOS’. As shown, BIOS NV-RAM 190 may include BIOS firmware 192, representing pre-boot instructions executable by processor subsystem 120, for example, for preparing information handling system 100 to boot by performing a power-on self-test (POST) or activating various hardware components in preparation of launching operating system 132 for execution. In certain embodiments, BIOS NV-RAM 190 complies with a Unified Extensible Firmware Interface (UEFI) specification promulgated by the UEFI Forum (UEFI.org).

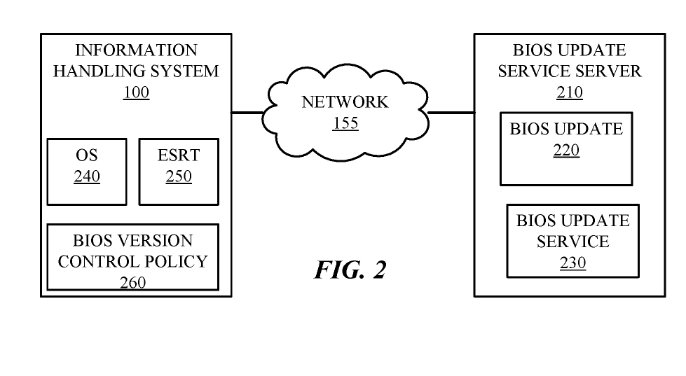

In one or more embodiments, when information handling system 100 is powered on or reset, firmware boot loaders may initialize the minimal set of hardware required for operation of the information handling system 100. The information handling system 100 may then be booted into a UEFI environment where BIOS firmware 192 continues the boot process. As referred to herein, BIOS firmware 192 may represent instructions executing on processor subsystem 120. It is noted that other processors or processor subsystems or both, such as an embedded controller (EC) or a secondary processor (not shown), may be used to execute BIOS firmware 192 in various embodiments. When BIOS firmware 192 executes, BIOS firmware 192 may be enabled to receive or determine a BIOS version control policy (element 260 of FIG. 2) for the information handling system 100 and to control BIOS updates based, at least in part, on that policy.

In one or more embodiments, a BIOS interface 194 may provide an interface to the BIOS firmware 192. BIOS interface 194 may be located in memory 130, BIOS NV RAM 190, or any other suitable storage location of information handling system 100. In one or more embodiments BIOS interface 194 may be located external to or remote from the information handling system 100. For example, BIOS interface 194 may provide an interface for managing or populating one or more BIOS settings, for example, by a user or a system administrator.

In one or more embodiments, the versions of BIOS firmware 192 installed on a given information handle system 100 may need to be controlled to maintain system and environment integrity. For example, within a corporate environment, a plurality of information handling systems 100 may include various applications. The proper operation of these applications may require a specific or range of BIOS versions to be installed on an information handling system 100. For example, a given application may not function properly on an information handling system 100 that has a BIOS firmware 192 installed newer (for example, released later in time) than a predetermined version of BIOS.

FIG. 2 is a block diagram of selected elements of an embodiment of an information handling system for controlling updates to a BIOS. In one or more embodiments, an information handling system 100 may receive one or more BIOS updates 220 from a BIOS update service 230 of a BIOS update service server 210, for example, from a Windows Update (WU) or Linux Vendor Firmware Service (LVFS) server. Generally, BIOS update services 230 automatically update the BIOS firmware 192 of an information handling system 100 when a new BIOS update 220 (for example, a new BIOS version) is posted, published or distributed on the BIOS update service server 210. This automatic update may not be desired or wanted by a user. For example, in certain environment, such as a corporate environment or governmental environment, an update to the BIOS firmware 192 may not be desired or wanted without first performing system checks to verify that the new BIOS version or BIOS update 220 will not disrupt current system and application operation or introduce security flaws. The BIOS update service 230 may automatically update a BIOS firmware 192 of an information handling system 100 even if the information handling system 100 is locked with an administrator password (for example, the BIOS interface associated with updating the BIOS firmware 192 is not available to a user without proper authentication). For example, once an information handling system 100 is booted to the OS, a connection with a BIOS update service server 210 may be established. An automatic update to one or more firmware components or devices, such as BIOS firmware 192, may occur.

In one or more embodiments, the BIOS firmware 192 of information handling system 100 may be UEFI compatible firmware. The UEFI specification defines an interface between an operating system (OS) 240 of an information handling system 100 and firmware, such as BIOS firmware 192. The interface of the UEFI comprises data tables that contain platform information (information related to the specific information handling system 100), boot and runtime service calls that are available to the OS and the associated OS loader. In this manner, UEFI compatible BIOS firmware provides a standard, modern environment for securely booting an OS 240 and running pre-boot applications on an information handling system 100. The BIOS version control policy 260 may allow a user or administrator to control automatic updates of the BIOS firmware 192. The BIOS version control policy 260 may be applied or associated with one or more information handling system 100. For example, a system administrator may implement a single BIOS version control policy 260 across a plurality of information handling systems 100 to ensure that each of the information handling systems 100 have the same version of BIOS firmware 192. For example, in a corporate environment it may be advantageous for each information handling system 100 across the corporate network to have the same version of the BIOS firmware 192 to ensure operability with any one or more system resources and applications.

The UEFI compatible BIOS firmware 192 may comprise an Extensible Firmware Interface System Resource Table (ESRT) 250. The ESRT 250 comprises information indicative of any firmware device, for example, the BIOS firmware 192 for an information handling system 100. This information may include any one or more values that may be populated, for example, by core UEFI firmware. For example, the one or more values may be populated based, at least in part, on the BIOS version control policy 260. The one or more values or ESRT value may comprise a unique identifier, such as a globally unique identifier (GUID), indicative of the firmware component of the information handling system 100 that may be updated via update capsule. This unique identifier is passed into the UEFI update capsule run-time service as a parameter. An ESRT value may comprise a firmware type that identifies the type of firmware resource of information handling system 100, for example, unknown, system firmware, device firmware, UEFI driver, or any other type of firmware resource. An ESRT value may comprise the current firmware version, such as the current version of the BIOS firmware 192 for the information handling system 100. In general, a larger number represents a newer release. An ESRT value may comprise information related to the last attempted update to a firmware component. For example, one or more values may be indicative of the firmware version for the last attempted update and the status of that date (such as successful, unsuccessful, or any other event indicative of the status).

Generally, BIOS update services 230 distribute device packages via a BIOS update service server 210 which may comprise an information handling system 100, for example, a server, such as WU or LVFS BIOS update services server. In one or more embodiments, the BIOS update service server 210 may comprise any number of updates for any number of firmware devices or components. Each time a new BIOS version is available, the new BIOS update 220 is published or distributed to a BIOS update service server 210. An OS 240 for an information handling system 100 identifies the BIOS firmware 192 (for example, UEFI BIOS firmware) of the information handling system 100 as a device object by enumerating an entry of the ESRT 250. The specific firmware of information handling system 100 is identified by a GUID of the ESRT 250. The OS 240 may receive BIOS update information that a BIOS update 220 has been published at the BIOS update service server 210 or the OS 240 may query the BIOS update service 230 for BIOS update information related to available BIOS updates 220. The OS 240 may, based, at least in part, on the BIOS update information, identify a BIOS update 220 for installing by comparing one or more values of a packet to information associated with the BIOS update 220. For example, a GUID of the ESRT 250 may be compared to a GUID of the identified BIOS update 220. If the GUID of the ESRT 250 and the GUID of the identified BIOS update 220 match and the version of the BIOS update 220 is appropriate, the OS 240 will use a capsule mechanism of the UEFI to update the current BIOS firmware 192 with the identified BIOS update 220 from the BIOS update service server 210. Such updates may occur automatically and outside the control of a local user, an administrator, or other restrictions.

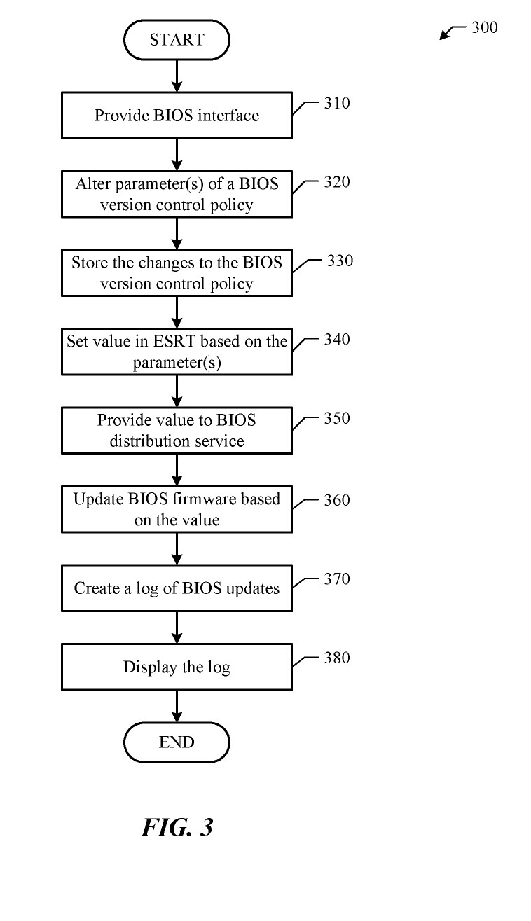

Turning now to FIG. 3, a block diagram of selected elements of an embodiment of method 300 for controlling BIOS updates is depicted in flowchart form. Method 300 may be performed using information handling system 100 (see FIG. 1 and FIG. 2). It is noted that certain operations described in method 300 may be optional or may be rearranged in different embodiments.

Method 300 may begin by providing a BIOS interface 194 at step 310. The BIOS interface 194 may be a command-line, graphical user interface or any other suitable type of interface. The BIOS interface 194 may be password protected or require other authentication prior to or during any interaction with the BIOS interface 194. The BIOS interface 194 may retrieve, display, provide access to, and allow alteration, changes or edits to one or more BIOS settings associated with the BIOS firmware 192. In one or more embodiments, an information handling system 100 includes a BIOS version control policy 260. One or more BIOS settings may be associated with the BIOS version control policy 260. In one or more embodiments the BIOS version control policy 260 comprises one or more parameters. The one or more parameters and the one or more BIOS settings may be retrieved, displayed, accessed, and altered, changed or edited via the BIOS interface 194.

The one or more parameters of the BIOS version control policy 260 determine or control updating of the BIOS firmware 192 and may be used to populate the ESRT 250. The one or more parameters of the BIOS version control policy 260 may comprise any one or more of a disable automatic updates, an enable automatic updates, and a permit predetermined updates which may also include a predetermined BIOS version. The disable automatic updates may indicate whether automatic updates to the BIOS firmware 192 such that a value associated with the disable automatic updates is indicative of not permitting any automatic BIOS updates to the BIOS firmware 192. The enable automatic updates may indicate whether automatic BIOS updates are permitted to the BIOS firmware 192 such that a value associated with the enable automatic updates is indicative of permitting automatic BIOS updates to the BIOS firmware 192. The BIOS firmware 192 will always update to the latest version of the BIOS update 220 available when automatic updates are enabled. In one or more embodiments, the enable and disable automatic updates may be a single setting with a binary value. For example, a setting of “1” may indicate automatic updates are enabled while a setting of “0” may indicate automatic updates are disabled. The permit predetermined updates may indicate that only updates up to and including a predetermined BIOS version are permitted for BIOS firmware 192. The predetermined BIOS version may be stored as a parameter associated with the BIOS version control policy 260.

At step 320, at least one of the one or more parameters of the BIOS version control policy 260 are altered. Any of the one or more parameters may be altered via the BIOS interface 194. In one example, at least one of the one or more parameters of the BIOS version control policy 260 indicates that automatic BIOS updates are not allowed or permitted. In another example, at least one of the one or more parameters of the BIOS version control policy 260 indicates that a BIOS update version cannot exceed a predetermined BIOS version. At step 330, the one or more parameters associated with the BIOS version control policy 260 or any other BIOS setting may be stored.

At step 340, one or more values associated with automatic updating of the BIOS firmware 192 are populated in the ESRT 250 based, at least in part, on at least one of the one or more parameters associated with the BIOS version control policy 260. The one or more values may comprise as discussed above a unique identifier and current version of the BIOS firmware 192. Each firmware device using the ESRT update method will add an entry or one or more values to the ESRT containing information associated with the firmware device. For example, the information may include any one or more of a GUID, type of firmware device, manufacturer or vendor of the firmware device, current version of firmware device, lowest or earliest firmware version permitted or any other information associated with the firmware device. The ESRT 250 may be dynamically updated with the one or more values or may be updated on the occurrence of certain events or in any other suitable manner.

In one or more embodiments, if the BIOS version control policy 260 indicates automatic updates are enabled, then the ESRT 250 may be populated with a unique identifier associated with BIOS firmware 192, such as GUID, and a BIOS version that corresponds to the current version of the BIOS firmware 192. In one or more embodiments, if the BIOS version control policy 260 indicates automatic updates are disabled then the ESRT 250 may be populated with the unique identifier associated with the BIOS firmware 192 and a BIOS version that corresponds to a NULL value or any other value that indicates to the BIOS update service 230 not to send or transmit the BIOS update 220. In one or more embodiments, the one or more values of the ESRT 250 associated with BIOS firmware 192 may be deleted to disable automatic BIOS updates. In one or more embodiments, if the BIOS version control policy 260 indicates predetermined updates are permitted, it is determined whether the current version of the BIOS firmware 192 matches the predetermined BIOS version. If a match occurs, then the ESRT 250 is populated in the same manner as for disable automatic updates to prevent any further updates to the BIOS firmware 192. If a match does not occur, then the ESRT 250 is populated in the same manner as for enable automatic updates. In one example, it is desired to roll back the version of the BIOS firmware 192. In this example, the predetermined BIOS version is indicative of a version that is older than the current version of the BIOS firmware 192 such that the BIOS version of the ESRT 250 is populated with a BIOS version that is not indicative of the current version of the BIOS firmware 192. The BIOS update service 230 will update the BIOS firmware 192 with only those BIOS updates 220 that correspond to this older BIOS version. In another example, the predetermined BIOS version is indicative of a version that is newer than the current version of the BIOS firmware 192 such that the BIOS version of the ESRT 250 is populated with a BIOS version that is indicative of the current version of the BIOS firmware 1912. The BIOS version control policy 260 will permit updates from the BIOS update service 230 until the predetermined BIOS version is reached.

At step 350, the one or more values from the ESRT 250 associated with BIOS firmware 192 are provided or transmitted to the BIOS update service 230. In one or more embodiments, after the information handling system 100 has booted the OS 240, a query may be received from the BIOS update service 230. In response to the query, the information handling system 100 may transmit the value (for example, a payload or packet) that comprises one or more of a unique identifier, such as a GUID, and the BIOS version from the ESRT 250. The BIOS update service 230 may format the one or more values received for processing by the BIOS update service 230. The BIOS update service 230 may determine if a BIOS update 220 is available at the BIOS update service server 210 based, at least in part, on the one or more values received. For example, the BIOS update service 230 may determine if any BIOS updates 220 are available that correspond to the unique identifier and that are newer than the BIOS version.

At step 360, a BIOS update 220 may be communicated to the information handling system 100 so that the BIOS firmware 192 may be updated. For example, if it is determined that a BIOS update 220 is available that corresponds to the one or more values then the BIOS update service 230 will transmit a capsule update to the information handling system 100. The OS 240 of the information handling system 100 receives the capsule and begins the process of installing the BIOS update 220. If the BIOS version control policy 260 indicates that predetermined updates are permitted, then steps 340 and 350 may be iteratively repeated until the version of the BIOS update 220 matches the predetermined BIOS version or no BIOS update 220 is available that does not exceed the predetermined BIOS version. For example, the latest available BIOS update 220 may have a version that is less than the predetermined BIOS version and thus no further updates will occur until another version is made available. In another example, the next available BIOS update 220 may have a version that exceeds the predetermined BIOS version and thus no further updates will occur as described above.

At step 370 a log may be created of each update to the BIOS firmware 192. For example, the log may comprise one or more entries that include for each update a timestamp, where the timestamp comprises one or more of the date and time, a version, a source, transmission time, update status (for example, successful, unsuccessful, an error code, or any other indicator of the status), one or more parameters associated with the BIOS version control policy, and any other information associated with the updates. At step 380, the log may be displayed or published. For example, the log may be displayed on a display device or may be published to one or more applications.

While the above illustrates one or more embodiments for controlling automatic updates to a BIOS firmware 192 according to a BIOS version control policy 260, the present invention contemplates that automatic updates to any firmware component or device may likewise be controlled or managed in a similar manner using an associated version control policy.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

To illustrate the interchangeability of hardware and software, items such as the various illustrative blocks, modules, elements, components, methods, operations, steps, and algorithms have been described generally in terms of their functionality. Whether such functionality is implemented as hardware or software depends upon the particular application and design constraints imposed on the overall system. Skilled artisans may implement the described functionality in varying ways for each particular application.

In one aspect, “means,” a block, a module, an element, a component or a processor may be an item (for example, one or more of blocks, modules, elements, components or processors) for performing one or more functions or operations. In one aspect, such an item may be an apparatus, hardware, or a portion thereof. In one example, an item may have a structure in the form of, for example, an instruction(s) encoded or stored on a machine-readable medium, on another device, or on a portion thereof. An instruction(s) may be software, an application(s), a subroutine(s), or a portion thereof. The instructions(s) may be for performing the function(s) or operation(s). The instruction(s) may be executable by one or more processors to perform the function(s) or operation(s). One or more processors may execute the instruction(s) by, for example, transferring or copying and instructions into an executable memory space and executing the instructions. In one example, an item may be implemented as one or more circuits configured to perform the function(s) or operation(s). A circuit may include one or more circuits and/or logic. A circuit may be analog and/or digital. A circuit may be electrical and/or optical. A circuit may include transistors. In an example, one or more items may be implemented as a processing system (for example, a DSP, an ASIC, an FPGA, etc.), as a portion(s) of any of the foregoing, or as a combination(s) of any of the foregoing. Those skilled in the art will recognize how to implement the instructions, circuits, and processing systems.

In one aspect of the disclosure, when actions or functions (for example, hooking, modifying, intercepting, redirecting, determining, traversing, obtaining, creating, operating, deleting, removing, receiving, providing, generating, converting, displaying, notifying, accepting, selecting, controlling, transmitting, reporting, sending, or any other action or function) are described as being performed by an item (for example, one or more of blocks, modules, elements, components or processors), it is understood that such actions or functions may be performed, for example, by the item directly. In another example, when an item is described as performing an action, the item may be understood to perform the action indirectly, for example, by facilitating such an action (for example, assisting, allowing, enabling, causing, or providing for, such action to occur; or performing a portion of such an action). For example, determining can refer to facilitating determination, attaching can refer to facilitating attaching, and receiving can refer to facilitating receiving. In one aspect, performing an action may refer to performing a portion of the action (for example, performing a beginning part of the action, performing an end part of the action, or performing a middle portion of the action).

A reference to an element in the singular is not intended to mean “one and only one” unless specifically so stated, but rather “one or more.” For example, a client may refer to one or more clients, a server may refer to one or more servers, an operation may refer to one or more operations, and a signal, message, or communication may refer to one or more signals, messages, or communications.

Unless specifically stated otherwise, the term “some” refers to one or more. Pronouns in the masculine (for example, his) include the feminine and neuter gender (for example, her and its) and vice versa. Headings and subheadings, if any, are used for convenience only and do not limit the invention.

A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain.

In one aspect, the term “coupled” or the like may refer to being directly coupled. In another aspect, the term “coupled” or the like may refer to being indirectly coupled or communicatively coupled.

Various items may be arranged differently (for example, arranged in a different order, or partitioned in a different way) all without departing from the scope of the subject technology. In one aspect of the disclosure, the elements recited in the accompanying claims may be performed by one or more modules or sub-modules.

It is understood that the specific order or hierarchy of steps, operations or processes disclosed is an illustration of exemplary approaches. Based upon design preferences, it is understood that the specific order or hierarchy of steps, operations or processes may be rearranged. Some of the steps, operations or processes may be performed simultaneously. Some or all of the steps, operations, or processes may be performed automatically, without the intervention of a user. The accompanying method claims, if any, present elements of the various steps, operations or processes in a sample order, and are not meant to be limited to the specific order or hierarchy presented.

The disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirement of 35 U.S.C. §101, 102, or 103, nor should they be interpreted in such a way. Any unintended embracement of such subject matter is hereby disclaimed.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method for version control of a basic input/output system (BIOS) of an information handling system, comprising:
providing an interface for the BIOS;
altering one or more parameters via the interface, wherein the one or more parameters are associated with a version control policy for the BIOS;
populating one or more values of an extensible firmware interface system resource table (ESRT) based, at least in part, on the one or more parameters, wherein the one or more values are indicative of a unique identifier associated with the BIOS and a BIOS version, and wherein the BIOS version is based, at least in part, on the version control policy;
providing the one or more values to a BIOS distribution service; and
updating the BIOS of the information handling system with a BIOS update from the BIOS distribution service based, at least in part, on the one or more values.

2. The method of claim 1, wherein the version control policy is associated with a plurality of information handling systems.

3. The method of claim 1, wherein the one or more parameters comprise at least one of enable automatic updates, disable automatic updates and permit predetermined updates.

4. The method of claim 3, wherein altering the one or more parameters comprises altering the enable automatic updates to allow automatic updates of the BIOS by the distribution service, and wherein the BIOS version comprises a current version of the BIOS.

5. The method of claim 3, wherein altering the one or more parameters comprises altering the disable automatic updates to prevent automatic updates of the BIOS by the distribution service, and wherein the BIOS version comprises an empty value.

6. The method of claim 3, wherein altering the one or more parameters comprises altering the permit predetermined updates to restrict updates of the BIOS by the distribution service, wherein the one or more parameters comprises a predetermined BIOS version, and wherein the BIOS version comprises the predetermined BIOS version.

7. The method of claim 6, wherein the predetermined BIOS version is an earlier version than a current version of the BIOS.

8. An information handling system, comprising:
a memory; and
a processor coupled to the memory, wherein the processor has access to a basic input/output system (BIOS), wherein the BIOS includes one or more instructions stored in the memory and executable by the processor to:
provide an interface for the BIOS of the information handling system;
alter one or more parameters via the interface, wherein the one or more parameters are associated with a version control policy for the BIOS of the information handling system, and wherein the version control policy provides a target BIOS version;
set a value of an extensible firmware interface system resource table (ESRT) based, at least in part, on the one or more parameters, wherein the value is indicative of the target BIOS version;
provide the value to a BIOS distribution service; and
update the BIOS of the information handling system with a BIOS update from the BIOS distribution service based, at least in part, on the value.

9. The information handling system of claim 8, wherein the information handling system comprises a plurality of information handling systems, and wherein the version control policy is associated with a plurality of information handling systems.

10. The information handling system of claim 8, wherein the one or more parameters comprise at least one of enable automatic updates, disable automatic updates and permit predetermined updates.

11. The information handling system of claim 10, wherein altering the one or more parameters comprises altering the enable automatic updates to allow automatic updates of the BIOS by the distribution service, and wherein the BIOS version comprises a current version of the BIOS.

12. The information handling system of claim 10, wherein altering the one or more parameters comprises altering the disable automatic updates to prevent automatic updates of the BIOS by the distribution service, and wherein the BIOS version comprises an empty value.

13. The information handling system of claim 10, wherein altering the one or more parameters comprises altering the permit predetermined updates to restrict updates of the BIOS by the distribution service, wherein the one or more parameters comprises a predetermined BIOS version, and wherein the BIOS version comprises the predetermined BIOS version.

14. The information handling system of claim 13, wherein the predetermined BIOS version is an earlier version than a current version of the BIOS.

15. A non-transitory computer-readable medium storing one or more instructions, the one or more instructions representing a basic input/output system (BIOS), that, when executed by a processor of an information handling system, cause the processor to:
receive a version control policy associated with the information handling system;
determine a version of the BIOS of the information handling system;
provide via an interface a version control policy for the BIOS of the information handling system, wherein the BIOS of the information handling system comprises unified extensible firmware interface (UEFI) firmware, and wherein the version control policy comprises the version of the BIOS of the information handling system and a target BIOS version;
alter one or more parameters of the version control policy via the interface;
set a value of an extensible firmware interface system resource table (ESRT) based, at least in part, on the one or more parameters, wherein the value is indicative of the target BIOS version;
receive a request from a BIOS distribution service;
provide the value to a BIOS distribution service in response to the request; and
update the BIOS of the information handling system with a BIOS update from the BIOS distribution service based, at least in part, on the value.

16. A non-transitory computer-readable medium of claim 15, wherein the version control policy is associated with a plurality of information handling systems.

17. A non-transitory computer-readable medium of claim 15, wherein the one or more parameters comprise at least one of enable automatic updates, disable automatic updates and permit predetermined updates.

18. A non-transitory computer-readable medium of claim 17, wherein altering the one or more parameters comprises altering the enable automatic updates to allow automatic updates of the BIOS by the distribution service, and wherein the BIOS version comprises a current version of the BIOS.

19. A non-transitory computer-readable medium of claim 17, wherein altering the one or more parameters comprises altering the disable automatic updates to prevent automatic updates of the BIOS by the distribution service, and wherein the BIOS version comprises an empty value.

20. A non-transitory computer-readable medium of claim 17, wherein altering the one or more parameters comprises altering the permit predetermined updates to restrict updates of the BIOS by the distribution service, wherein the one or more parameters comprises a predetermined BIOS version, and wherein the BIOS version comprises the predetermined BIOS version.
